(19) United States
(12) Patent Application Publication
(10) Pub. No.: US 2013/0335552 A1
(43) Pub. Date: Dec. 19, 2013

(54) METHOD FOR MASK INSPECTION, AND MASK INSPECTION INSTALLATION

(71) Applicants: Heiko Feldmann, Aalen (DE); Michael Totzeck, Schwaebisch Gmuend (DE)

(72) Inventors: Heiko Feldmann, Aalen (DE); Michael Totzeck, Schwaebisch Gmuend (DE)

(73) Assignees: CARL ZEISS AG, Oberkochen (DE); CARL ZEISS SMT GMBH, Oberkochen (DE)

(21) Appl. No.: 13/994,797

(22) PCT Filed: Dec. 8, 2011
(86) PCT No.: PCT/EP11/06171

§ 371 Date: Sep. 5, 2013

(30) Foreign Application Priority Data
Dec. 17, 2010 (DE) 10 2010 063 337.2

(51) Int. Cl. H04N 7/18

(52) U.S. Cl. CPC H04N 7/18
USPC 348/86

(57) ABSTRACT

The invention relates to a method for mask inspection and to a mask inspection installation. A method according to the invention involves a lighting system lighting a mask with a lighting beam pencil, and said mask being observed with an observation beam pencil which is directed onto a sensor arrangement, wherein the light hitting the sensor arrangement is evaluated in order to check the mapping effect of the mask. The lighting system produces a spot of light with limited refraction on the mask, and during the evaluation of the light hitting the sensor arrangement a finite component of the light setting out from the mask to produce the observation beam pencil is disregarded.

The invention relates to a method for mask inspection as well as to a mask inspection installation.

Microlithography is used for the manufacture of microstructured components such as, for example, integrated circuits or LCDs. The microlithography process is carried out in a so-called projection exposure installation having an exposure unit and a projection lens. The image of a mask (reticle) exposed by means of an exposure unit is projected here by means of the projection lens onto a substrate (a silicon wafer, for example) that is coated with a light-sensitive layer (photoresist) and arranged on the image plane of the projection lens in order to transfer the mask structure onto the light-sensitive layer of the substrate.

In the lithography process, undesired defects have an especially disadvantageous effect on the mask, since they can be reproduced with any exposure step and there is consequently the danger, in the worst of cases, of the entire production run of semiconductor components being unusable. It is therefore of great importance to check the mask for sufficient imaging capability before use thereof in mass production. In practice, one problem that arises here, among others, is that depending on the shape of the defects as well as the position thereof with respect to the structure to be reproduced, deviations in the imaging performance can occur that are difficult to foresee. To minimize mask defects and to perform successful mask repair, the ability to immediately analyze the imaging effect of possible defective items is therefore desirable. There is therefore a need for quick and easy testing of the mask, particularly under conditions that come closest to those actually present in the projection exposure installation.

It should be kept in mind that different degrees of coherence of the light, different exposure settings and increasingly large numerical apertures are set in the exposure unit, which pose difficult practical challenges with regards to the emulation or reproduction of the imaging performance of the projection exposure installation during mask inspection. Particularly, in order to optimize imaging performance, exposure settings such as, for example, a dipole or quadrupole exposure setting that results in partial coherence of the exposure light striking the mask is used in the exposure unit of the projection exposure installation, with changes being made between different exposure settings (in certain circumstances even with different polarization distributions) in order to adapt to the respective mask structure.

In the above context, it is an object of the present invention to provide a method for mask inspection as well as a mask inspection installation which enable the emulation of the conditions present in the projection exposure installation with little equipment cost.

This object is achieved by the method according to the features of independent patent claim 1 as well as by the device according to dependent patent claim 12.

In a method according to the invention for operating a mask inspection installation, an exposure system exposes a mask with a bundle of rays, this mask being observed with a bundle of observation rays which is deflected to a sensor arrangement, the light incident on the sensor arrangement being analyzed to check the imaging effect of the mask.

The method is characterized in that the exposure system generates a diffraction-limited light spot on the mask, and that, during the analysis of the light incident on the sensor arrangement, a finite portion of the light emanating from the mask generated by the bundle of observation rays is disregarded.

As a result of disregarding a finite portion of the light emanating from the mask that is generated by the bundle of observation rays, certain directions that are used to observe the diffraction-limited light spot are selected during mask inspection in a targeted manner. In doing so, as a result of “disregarding” a portion of the light emanating from the mask, targeted setting, as it were, of the shape of the effective bundle of observation rays, which contributes to the final imaging in the mask inspection installation, occurs. As a result, as explained in further detail below and despite the use of completely coherent exposure in the mask inspection installation, a partially coherent exposure used in the subsequent lithography process in the projection exposure installation can be emulated, this emulation now occurring in the projection lens system of the mask inspection installation.

In particular, the invention is based on simulating the conditions present in the projection exposure installation in a mask inspection installation embodied as a scanning microscope. The lens system of this scanning microscope is designed such that it emulates the projection lens system of the projection exposure installation. The image sensor or the image recording of this scanning microscope is designed such that the exposure lens system of the projection exposure installation is emulated. In other words, the imaging lens system and the exposure lens system reverse roles with each other in a certain sense in the mask inspection installation with regard to the emulation of the projection exposure installation.

By virtue of the invention, the equipment cost can be significantly reduced compared to a conventional mask inspection installation, since only a single light spot or spots need to be confocally produced or exposed, so a simple beam-shaping unit can be used as the exposure system that focuses the light of the (laser) light source onto a point on the mask. The beam-shaping unit can particularly be comprised of a single lens. Moreover, in the mask inspection installation according to the invention, no lens system at all is required in principle between the mask and the sensor arrangement, since the only important thing in relation to the image sensor during image recording is the emulation of the exposure lens system of the projection exposure installation (and particularly its partial coherence) which, as explained below, can be done using a diaphragm or through a targeted, particularly subsequent, selection of the photons considered in the analysis striking the image sensor. As a result, a mask inspection installation can therefore be realized which has a particularly compact construction.

Due to the compact construction, one advantageous application of the invention consists in providing mask inspection as an additional functionality in a mask repairing machine, in which the repairing of masks is performed typically using ion beams and in which immediate quality control is made possible as a result of the implementation of the mask inspection enabled by the compact construction according to the invention. Furthermore, the invention can also be implemented in other devices for mask inspection as well (which only detect defects in the mask without analyzing the impact thereof on the lithography process) as an additional module in order to additionally enable a characterization of the encountered defects with respect to their impact on the lithography process (for instance, in connection with a certain exposure setting).

According to one embodiment, a scanning motion of the light spot is carried out relative to the mask in order to check the imaging effect of the mask (the expense associated with a scanning process being consciously accepted in this respect, especially since an already existing infrastructure, such as the scanning device of the projection exposure installation, may be able to be used). The scanning process carried out in the mask inspection installation can occur either through movement only of the beam-shaping lens system or lens of the exposure system generating the light spot, through movement of beam-shaping lens system or lens of the exposure system and sensor arrangement, or through movement only of the mask while the beam-shaping lens system and sensor arrangement are kept stationary.

The invention can be implemented both in the EUV range (i.e., at wavelengths of about 13 nm or about 7 nm, for example) or even in the UV or DUV range (e.g., at wavelengths of less than 250 nm, particularly less than 200 nm). The mask inspected in the mask inspection installation can therefore be either a reflecting reticle (intended for an EUV projection exposure installation) or a transmitting reticle (for a projection exposure installation intended for the DUV or UV range).

The invention is based on the initially surprising insight that it is possible, with the aid of a completely coherent exposure in the exposure system of the mask inspection installation, to simulate a partial coherence in the projection exposure installation.

The equivalence of the results that are achieved in the sensor arrangement and recognized by the inventors in the mask inspection installation is obtained through the combination of a completely coherent exposure with the emulation of partial coherence. Using a partially coherent exposure (in which the light waves present in the system are only partially coherent with respect to each other or several mutually independent oscillating electrical fields exist, so the exposure occurs simultaneously from several directions that are incoherent with each other), the equivalence of the results of a conventional mask inspection installation is demonstrated in the following:

According to the theory of partial coherence, a detector signal at location x is given by:

I(x)=∫dv₁dv₂dx₂dx₂dv

exp(2πi(v₁x−v₂x))P(v₁)P(v₂)

exp(−2πi(v₁x−v₂x))T(x₁)T(x₂)

exp(2πi(vx₁−vx₂))S(v)S^{*}(v) (1)

In equation (1), “v” stands for pupil coordinates of the illumination pupil and “x” for location coordinates. v₁ and v₂ are coordinates of the objective pupil, x₁ and x₂ are coordinates of the object plane, and P(v) refers to the so-called aperture function of the imaging lens system, which describes cropping and aberrations as applicable. T(x) refers to the transmission/reflection of the object, where T(x) can also contain phase shifts (e.g., through phase-shifting masks). S(v) refers to the filling of the illumination pupil, so that the exposure setting is given by S(v). According to the theory of partial coherence, different points of the illumination pupil are incoherent to each other.

For a completely coherent exposure in terms of the invention, the detector signal, upon focusing of the illumination on a point x, is given by:

I(x)=∫dv₁dv₂dx₁dx₂dv

exp(−2πi(v₁x−v₂x))S(v₁)S(v₂)

exp(2πi(v₁x−v₂x₂))T(x)T(x₂)

exp(−2πi(vx₁−vx₂))P(v)P^{*}(v) (2)

In equation (2), “v” stands for pupil coordinates and “x” for location coordinates. v refers to the coordinates in the far field of the mask (i.e., the coordinates on the sensor arrangement or the CCD array), v₁ and v₂ are coordinates of the illumination pupil, x₁ and x₂ are coordinates of the object plane. P(v) describes the diaphragm in front of the sensor arrangement and takes into account the selection of the CCD pixels. Optionally, aberrations of a lens system in front of the sensor arrangement are also taken into account. T(x) refers to the transmission/reflection of the object, where T(x) can also contain phase shifts (e.g., through phase-shifting masks). S(v) refers to the filling and phase position of the illumination pupil. All areas of the illumination pupil are coherent to each other.

Table 1 shows and compares the equivalence of the results that are achieved in relation to the invention in the mask inspection installation through combination of a completely coherent exposure with the emulation of partial coherence in the sensor arrangement and the results of a conventional mask inspection installation using partially coherent exposure:

TABLE 1

| Invention | | Prior art |
|---|---|---|
| (Completely coherent exposure; | | (Mask inspection installation |
| emulation of partial coherence | | using partially coherent |
| in the sensor arrangement) | | exposure) |
| P(ν) | ≡ | S(ν) Exposure setting |
| Diaphragm in front of | | |
| sensor and | | |
| selection of the CCD pixels | | |
| taken into account | | |
| T(x) | ≡ | T(x) |
| Object transmission and | | Object transmission and |
| phase | | phase |
| S(ν) | ≡ | P(ν) |
| (Cropping and phase) | | (Diaphragm of the imaging |
| | | lens system and objective |
| | | aberrations) |

As a result of the replacements according to Table 1, the expressions for I(x) merge into one another in the preceding equations (1) and (2).

According to one embodiment, the finite portion of the bundle of observation rays is sorted through placement of a diaphragm in the beam path between the mask and the sensor arrangement.

According to another embodiment, the sensor arrangement has a plurality of pixels, and the sorting of the finite portion of the bundle of observation rays is done by only taking into account a portion (of less than 100%) of these pixels in the final imaging to produce a reproduction of an area of the mask. This final imaging can be done, for example, in a computer, so that the effective bundle of observation rays is not selected until it reaches the computer. This also makes it possible, for instance for a manufacturer of masks, for all of the (raw) data that are recorded during the mask inspection by the sensor arrangement to be made available to a chip manufacturer and then analyzed by the chip manufacturer in connection with one or more special exposure settings without having to know or specify the exposure setting(s) already before or during the recording of the raw data in the mask inspection.

According to one embodiment, a polarization manipulator (e.g., a polarization filter) can be placed in the beam path between the mask and the sensor arrangement. In this way, polarized exposure used, for example, in the lithography process in the exposure system of the projection exposure installation can be emulated. What is more, a polarization manipulator (e.g., a polarization filter) can also be placed in the exposure system of the mask inspection installation in order to emulate polarization effects or even vector effects (due to a high numerical aperture of the projection objective of the projection exposure installation) occurring in the lithography process.

According to another embodiment, obscuration (in an EUV projection objective, for instance) can also be emulated through placement of a diaphragm in the exposure system of the mask inspection installation.

Although the mask inspection installation according to the invention can be used advantageously particularly for use in lithography, the invention is not limited to this. The invention can also be implemented advantageously in a laser scanning microscope. In general, the invention can also be used in other mask inspection installations, particularly those in which objects are studied that are used in conjunction with partially coherent exposure.

According to another aspect, the invention relates to a method for the emulation of imaging characteristics which shows a mask in a microlithographic projection exposure installation, in a mask inspection installation having a sensor arrangement, wherein the mask is observed with a bundle of observation rays guided onto the sensor arrangement, wherein the mask is intended for use in conjunction with at least one predetermined exposure setting in the projection exposure installation, wherein emulation of this exposure setting is achieved by disregarding a finite portion of the light emanating from the mask and incident on the sensor arrangement under generation of the bundle of observation rays.

Preferred embodiments and advantages of the method are described in the remarks about the method according to the invention for mask inspection as described above.

Further embodiments of the invention follow from the description and the dependent claims. In the following, the invention is explained in further detail with reference to the exemplary embodiments depicted in the enclosed drawings.

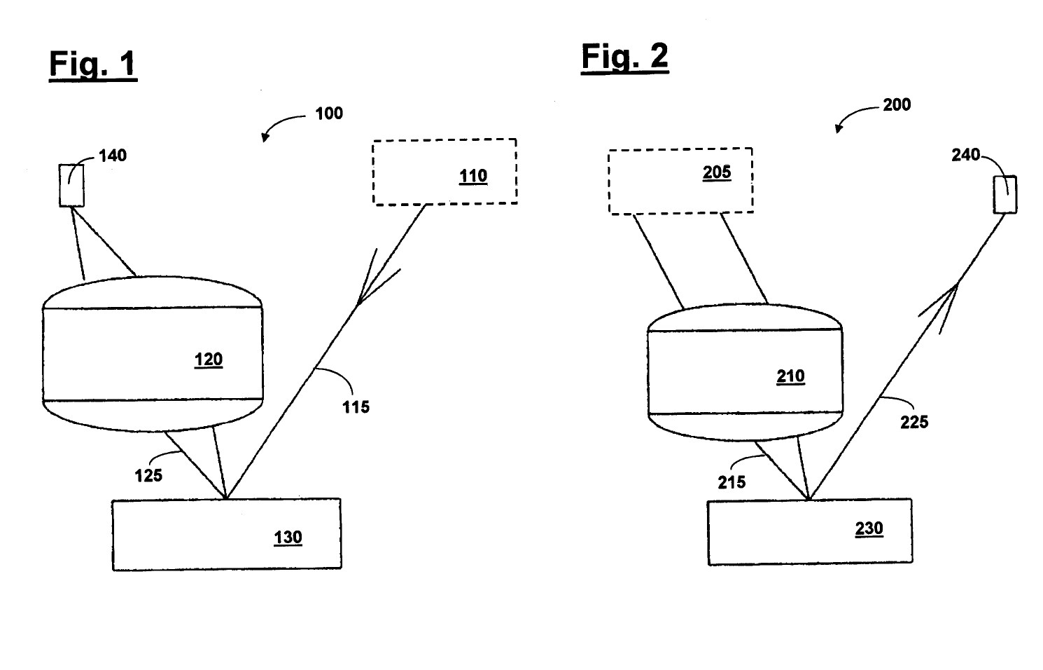

FIGS. 1-2 show schematic representations to illustrate and explain the principle of the present invention;

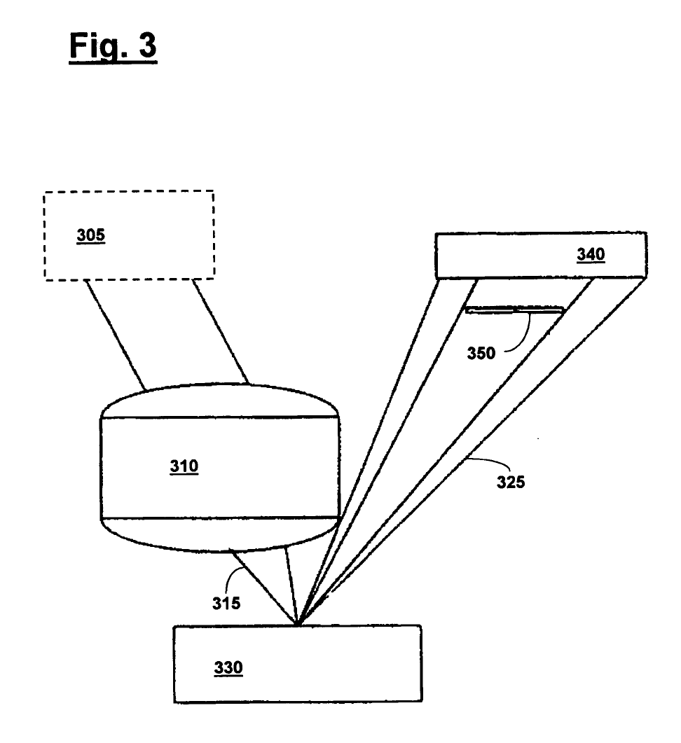

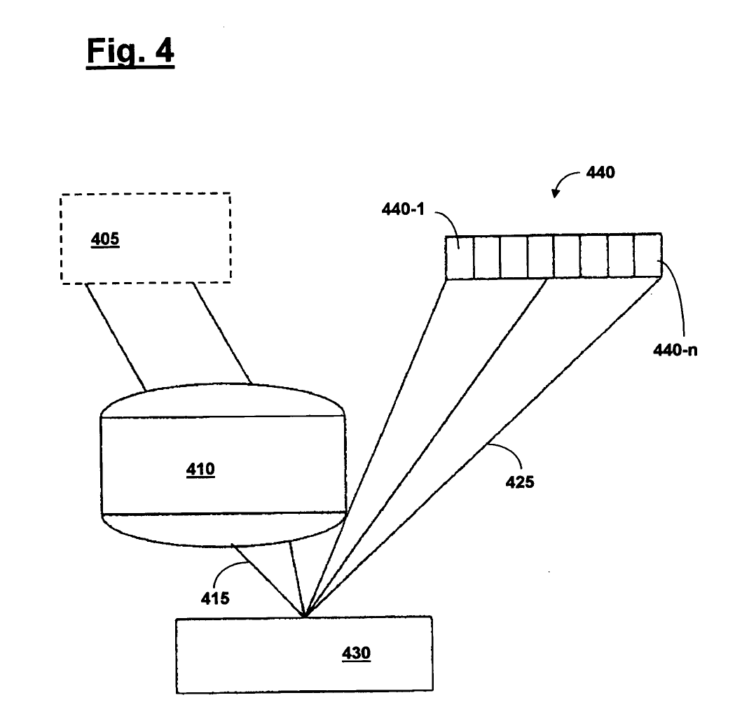

FIGS. 3-4 show schematic representations to explain possible embodiments of the invention; and

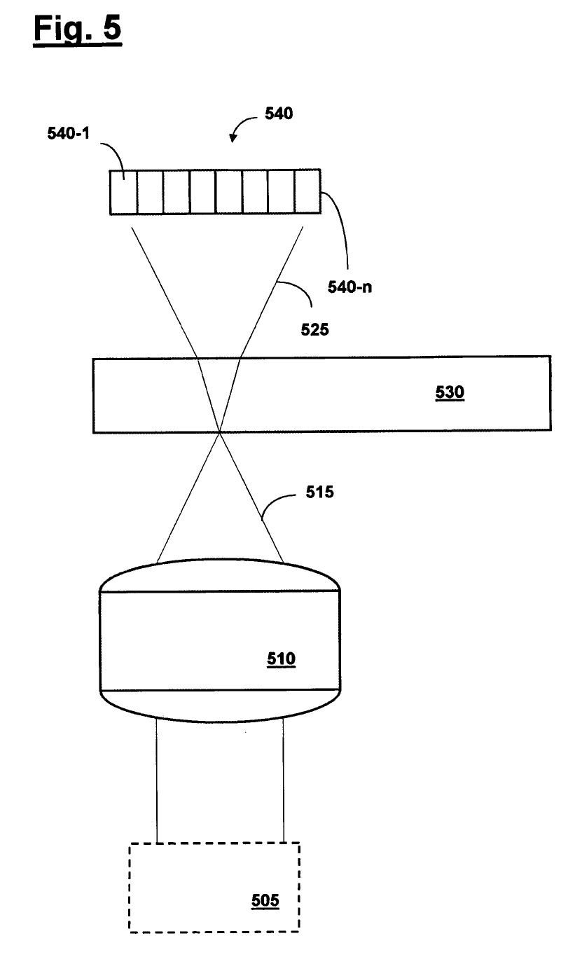

FIG. 5 shows a schematic representation of another embodiment of the invention using a transmissive mask.

Reference will now be made first to FIGS. 1 and 2 in order to explain the concept underlying the present invention.

As is shown merely in schematic fashion in FIG. 1, a conventional mask inspection installation 100 comprises an exposure system 110 and a projection objective 120, wherein light from a light source (not shown in FIG. 1) enters the exposure system 110 and guides a bundle of exposure rays 115 onto a mask 130 arranged on the object plane of the projection objective 120, and wherein the exposed area of the mask 130 is imaged onto a sensor arrangement 140, e.g., a CCD camera, via a bundle of observation rays 125 by means of the projection objective 120.

Now, during mask inspection, in order to reproduce, to the greatest extent possible, the exposure settings that are encountered by the projection exposure installation or the scanner in the actual lithography process, it is important to also emulate the exposure settings used in the projection exposure installation and its exposure unit in connection with the mask 130, that is, the partial coherence of the exposure light incident on the mask 130 that may occur with the exposure setting, for which purpose it is common, in turn, to use appropriate diaphragms (which is to say, for instance in the case of a quadrupole setting used in the subsequent lithography process, a quadrupole diaphragm with four cutouts adapted to the exposure poles), so a partially coherent exposure can be used in the mask inspection installation. Moreover, the parameters of the beam path, i.e., the NA, can also be reproduced in the projection objective 120 of the mask inspection installation 100 using an appropriate mask (typically with corresponding circular cutout).

The principle underlying the invention will be explained with reference to the likewise schematic representation of FIG. 2. According to FIG. 2, in turn, light from a light source 205 is incident on an exposure system 210 which focuses the exposure light onto a diffraction-limited light spot of a mask 230. Here, the exposure system 210 merely constitutes a beamshaping lens system which can be comprised particularly of a single lens. In contrast to a conventional mask inspection installation, in which a larger area of the mask is respectively exposed, a diffraction-limited light spot is therefore produced on the mask 230, this light spot emerging from a spherical wave which forms a coherent and focused wave front that tapers to a point.

The light source 205 is a monomode laser on which the only demand to be placed is that of sufficient image quality on the light spot, for which laser outputs in the milliwatt range are sufficient. The light of the monomode laser can also be coupled in from the outside by a glass fiber, for example. The exposure system 210, which produces the diffraction-limited light spot on the mask 230 from the laser light of the monomode laser, has a numerical aperture that corresponds to the numerical aperture of the projection objective of the projection exposure installation.

To check the imaging effect of the mask 230, a scanning motion of the diffraction-limited light spot is performed relative to the mask 230. Only for the sake of example (and without limiting the invention to it), an area of 5 μm*5 μm can be scanned during the scanning process, for example on the mask 230, in steps of 20 nm, so the mask in the example could be divided during the scanning process into 250 lines and 250 columns each with 250 individually scanned pixels (the size of the diffraction-limited light spot on the mask typically being somewhat larger than 20 nm, thus resulting in “over-scanning” in the example above).

The scanning process carried out according to the invention in the mask inspection installation 200 can take place either alone through the movement of the beam-shaping lens system or lens of the exposure system 210 producing the light spot, through the movement of the beam-shaping lens system or lens of the exposure system 210 and sensor arrangement 240, or even through the movement only of the mask 230 (with stationary beam-shaping lens system and sensor arrangement 240).

In principle, the mask inspection installation 200 does not need to have a moveable “reticle stage” or a moveable sensor arrangement. Consequently, the scanning process can also take place relatively quickly (the time period required to record an image lying merely in the range of tenths of a second).

Due to the fact that no high-resolution lens system is required between mask 230 or reticle and sensor arrangement 240, and given that the image field in a mask inspection installation 200 is typically only a few micrometers (μm) in size, movement of the sensor arrangement 240 is not necessarily required during scanning, since the measured result obtained is not substantially influenced if the sensor arrangement is kept stationary. In particular, the required range of motion of a few pm can be achieved relatively easily, for example by only moving the exposure lens system of the mask inspection installation.

If the sensor arrangement is arranged at a short distance from the reticle, additional Fourier optics can be arranged between mask 230 and sensor arrangement 240 in order to ensure that the sensor arrangement 240 in the far field.

Unlike the arrangement of FIG. 1, in the arrangement according to the invention of FIG. 2, only a single light spot is produced or a single pixel exposed on the mask 230. The consideration or reproduction or emulation of the parallel coherence is therefore done according to the invention not on the exposure side, but right after (i.e., downstream from) the mask 230 (with respect to the direction of light propagation), because only certain pixels of the sensor arrangement 240 are considered or “included in the count” in a targeted manner either during the measurement or during the analysis thereof.

In other words, instead of using diaphragms that are used in the exposure system of the conventional mask inspection installation 100 to produce partial coherence in order to deflect exposure light from different directions onto the mask 130, only a single diffraction-limited light spot is exposed on the mask. A highly simplified exposure system 210 (reduced to a single focusing lens, for example) can be used to reproduce or emulate an effective diaphragm shape by “disregarding” parts of the light emanating from the mask 230 that are due to the bundle of observation rays 225.

FIGS. 3 and 4 show different possibilities in which the concept according to the invention can be realized. According to

FIG. 3, a diaphragm 350 can be used for this purpose which ensures that only certain areas of a non-spatially resolved sensor 340 are exposed. The design of the diaphragm 350 is made to correspond to the exposure setting used in the subsequent lithography process (so, in the case of a quadrupole exposure setting, a quadrupole diaphragm having four cutouts adapted to the exposure pole is used).

According to FIG. 4, a spatially resolved sensor field or CCD array can also be used as a sensor arrangement 440 which collects all radiation striking it. Merely for the sake of example (and without limiting the invention to it), the CCD array can have a number of 100*100 pixels. During the subsequent image processing, the diaphragm 350 from the sample embodiment of FIG. 3 can now be emulated by only adding the light from selected pixels of the sensor arrangement 440 while “doing without” the remaining pixels, which ends up being commensurate with the physical effect of the diaphragm.

Above, different implementations for the emulation of partial coherence were described. In the exposure system of the mask inspection installation, light from a coherent laser light source was used in each case. In connection with this use of coherent light, a “shift” of the sensor of the projection lens system (or the analysis of other areas of a spatially resolved, flat sensor arrangement such as a CCD array) leads to the detection of sensor signals that also corresponds to fully coherent exposure but with shifted bundle of exposure rays. If the sensor signals or intensities for different sensor shifts or positions are now added, one obtains the same signal which corresponds to the partially coherent exposure.

A substantial advantage of the arrangement of FIG. 4 is that the design or shape of the diaphragm used in the subsequent lithography process need not yet be established or selected at the time of the imaging recording performed for the mask inspection, but rather this information is present after scanning and in the measurement computer and—depending on what diaphragm is selected in the lithography process—the analysis can be done afterwards by selecting the pixels of the sensor arrangement 440 to be added.

Consequently, the effect of different diaphragms can be reproduced in the projection exposure installation solely on the basis of a complete measurement cycle of the mask inspection installation. This also provides, in particular, the possibility of testing which diaphragm is best in conjunction with the respective mask structure based on the execution of a measurement carried out during the mask inspection. Unlike a typically purely software-based “source-mask optimization,” all of the manufacturing defects of the mask are already taken into account here.

FIG. 5 provides a schematic representation for explaining another embodiment of the invention. In it, components that are analogous or substantially functionally equivalent compared to FIG. 4 are designated with reference symbols that are each “100” higher. The construction of FIG. 5 differs from that of FIG. 4 in that, instead of the reflective mask 430, a transmissive mask 530 is used, so that the light incident on the mask 530 as a bundle of exposure rays 515 traverses the mask and, after transmission through the mask 530, strikes the sensor arrangement 540 as a bundle of observation rays 525.

Where the invention was also described on the basis of special embodiments, numerous variations and alternative embodiments are conceivable to the person skilled in the art, for example through the combination or exchanging of features of individual embodiments. Accordingly, as will readily be understood by the person skilled in the art, such variations and alternative embodiments are included in the present invention, and the scope of the invention is only limited by the enclosed patent claims and their equivalents.

1. Method for mask inspection, wherein an exposure system exposes a mask with a bundle of exposure rays and this mask is observed with a bundle of observation rays which is guided onto a sensor arrangement, the light incident on the sensor arrangement being analyzed to check the imaging effect of the mask, wherein the exposure system produces a diffraction-limited light spot on the mask, and that during the analysis of the light incident on the sensor arrangement, a finite portion of light emanating from the mask due to the bundle of observation rays is disregarded.

2. The method as set forth in claim 1, wherein a scanning motion of the light spot is carried out relative to the mask to check the imaging effect of the mask.

3. The method as set forth in claim 1, wherein sorting of a finite portion of the bundle of observation rays occurs through placement of at least one diaphragm in the beam path between the mask and the sensor arrangement.

4. The method as set forth in claim 1, wherein the sensor arrangement has a plurality of pixels, wherein a sorting of a finite portion of the bundle of observation rays is due to only a portion of less than 100% of these pixels being taken into account during the analysis of the light incident on the sensor arrangement.

5. The method as set forth in claim 1, wherein the exposure system comprises a single lens.

6. The method as set forth in claim 1, wherein a polarization manipulator is placed in the beam path between the mask and the sensor arrangement.

7. The method as set forth in claim 1, wherein the mask is configured to be used in lithography.

8. The method as set forth in claim 1, wherein the disregarded portion of the light emanating from the mask due to the bundle of observation rays corresponds to an intensity of at least 10%, particularly at least 30%, and more particularly at least 50% of the total intensity of the light emanating from the mask.

9. The method as set forth in claim 1, wherein at least two mutually independent analyses of the light incident on the sensor arrangement are performed which differ from one another with respect to the portion of light disregarded during the analysis emanating from the mask due to the bundle of observation rays.

10. The method for the emulation of imaging characteristics, which shows a mask in a microlithographic projection exposure installation, in a mask inspection installation having a sensor arrangement, wherein the mask is observed with a bundle of observation rays guided onto the sensor arrangement, wherein the mask is configured to be used in conjunction with at least one predetermined exposure setting in the projection exposure installation, wherein emulation of this exposure setting is achieved by disregarding a finite portion of the light emanating from the mask due to the bundle of observation rays during the analysis of the light incident on the sensor arrangement.

11. The method as set forth in claim 10, wherein in order to emulate different exposure settings, at least two mutually independent analyses of the light incident on the sensor arrangement are performed which differ from one another with respect to the portion of light disregarded during the analysis emanating from the mask due to the bundle of observation rays.

12. Mask inspection installation, comprising an exposure system which exposes a mask with a bundle of exposure rays during operation of the mask inspection installation, and a projection objective which observes this mask with a bundle of observation rays, wherein the mask inspection installation is designed to carry out a method in which the exposure system exposes the mask with the bundle of exposure rays and the mask is observed with the bundle of observation rays which is guided onto a sensor arrangement, the light incident on the sensor arrangement being analyzed to check the imaging effect of the mask, wherein the exposure system produces a diffraction-limited light spot on the mask, and that during the analysis of the light incident on the sensor arrangement, a finite portion of light emanating from the mask due to the bundle of observation rays is disregarded.

13. The mask inspection installation of claim 12, wherein a scanning motion of the light spot is carried out relative to the mask to check the imaging effect of the mask.

14. The mask inspection installation of claim 12, wherein sorting of a finite portion of the bundle of observation rays occurs through placement of at least one diaphragm in the beam path between the mask and the sensor arrangement.

15. The mask inspection installation of claim 12, wherein the sensor arrangement has a plurality of pixels, wherein a sorting of a finite portion of the bundle of observation rays is due to only a portion of less than 100% of these pixels being taken into account during the analysis of the light incident on the sensor arrangement.

16. The mask inspection installation of claim 12, wherein the exposure system comprises a single lens.

17. The mask inspection installation of claim 12, wherein a polarization manipulator is placed in the beam path between the mask and the sensor arrangement.

18. The mask inspection installation of claim 12, wherein the mask is configured to be used in lithography.

19. The mask inspection installation of claim 12, wherein the disregarded portion of the light emanating from the mask due to the bundle of observation rays corresponds to an intensity of at least 10%, particularly at least 30%, and more particularly at least 50% of the total intensity of the light emanating from the mask.

20. The mask inspection installation of claim 12, wherein at least two mutually independent analyses of the light incident on the sensor arrangement are performed which differ from one another with respect to the portion of light disregarded during the analysis emanating from the mask due to the bundle of observation rays.
